(19) United States
(12) Patent Application Publication
(10) Pub. No.: US 2014/0035479 A1
(43) Pub. Date: Feb. 6, 2014

(54) LED DRIVER CIRCUIT STRUCTURE WITH OVER-CURRENT SUPPRESSION

(71) Applicant: National Applied Research Laboratories, (US)

(72) Inventors: Yuan-Ta HSIEH, Hsinchu (TW); Chiao-Li Fang, Hsinchu (TW); Jian-Fu Wu, Hsinchu (TW); Hann-Huei Tsai, Hsinchu (TW); Ying-Zong Juang, Hsinchu (TW)

(73) Assignee: National Applied Research Laboratories, Hsinchu City (TW)

(21) Appl. No.: 13/649,767

(22) Filed: Oct. 11, 2012

(30) Foreign Application Priority Data
Aug. 1, 2012 (TW) 101127850

(51) Int. Cl. H05B 37/02

(52) U.S. Cl. 315/224

(57) ABSTRACT

An LED driver circuit structure with over-current suppression is provided. The LED driver circuit includes a DC-DC converter, a voltage detector, a reference voltage supplier module, an error amplifier, a comparator, and an SR-latch. The LED driver circuit structure controls the output voltage and thus the output current of the DC-DC converter by multi-step switching of reference voltages and current levels to achieve over-current suppression, thereby extending an LED endurance period and increasing a PWM dimming frequency range for LED brightness control applications.

### BACKGROUND OF THE INVENTION

1. Technical Field

The present invention relates to LED driver circuit structures with over-current suppression, and more particularly, to a LED driver circuit structure capable of effectuating over-current suppression by providing multi-step driving currents for LED modules.

2. Description of Related Art

Light-emitting diodes (LEDs), serving as a source of illumination, display, and backlight, have several advantages, such as long lifespan, wide color gamut, environment friendly, and high brightness dimming capability. Long LED lifespan not only means extension of the service life time of LEDs, but also means reduction of costs for product materials, tests, maintenance, and parts replacement.

Although LEDs, as developed, feature the advantage of long lifespan and play an increasingly important role of being a major light source of illumination, display, and backlight, the service life time of LEDs actually depends majorly on the ways of operation. More than often, the lifespan of LEDs is greatly reduced because of over specification driving currents (over-current). Conventional LED driving circuits and driving ICs are confronted with the over-current issue or subjected to pulse-width modulation (PWM) dimming frequency range limitations when adopting PWM-controlled dimming operations.

Referring to FIG. 1, there is shown a basic circuit diagram of a conventional boost LED driving circuit, wherein the voltage source V_{IN} supplies a current I_{LED} to an LED module via a boost DC-DC converter, and the magnitude of the current I_{LED} is determined by the DC-DC converter and the current sensor which connects to the LED module in series. Since an inductor features a current continuity property, the inductor will have to fully release its stored electric energy when the detected LED current by the current sensor is larger than expected. The release of such electric energy brings a high surge current to the LED module and that is the reason for a conventional LED driving circuit to have an over-current phenomenon.

The major developments of LED illumination technology will now take great importance in inventions to prevent the reduction in the lifespan of LEDs, and to widen the PWM dimming frequency range of LEDs by equipping a LED driving circuit with a control circuit mechanism, which suppresses an LED over-current phenomenon by setting multi-step LED reference current.

### SUMMARY OF THE INVENTION

The present invention provides an LED driver circuit structure with over-current suppression. The LED driver circuit structure comprises a DC-DC converter, a voltage detector, a reference voltage supplier module, an error amplifier, a comparator, and an SR-latch. It is an objective of the present invention to provide an LED driver circuit structure with over-current suppression to extend the lifespan of LEDs, and to increase the PWM dimming frequency range, thus to provide perfect illumination applications of LEDs.

In order to achieve the above and other objectives, the present invention provides an LED driver circuit structure with over-current suppression. The LED driver circuit structure comprises: a DC-DC converter for supplying driving power to an LED module; a reference voltage supplier module for supplying at least a pre-driving reference voltage and a designed reference voltage; a voltage detector connected in series with the LED module; an error amplifier; a comparator; and an SR-latch. With the DC-DC converter providing multi-step currents to the LED module, the LED driver circuit structure with over-current suppression of the present invention effectively suppresses LED over-current effects, extends the lifespan of the LED module, and increases the PWM dimming frequency range for effective LED brightness control.

In order to achieve the above and other objectives, the present invention further provides a LED over-current suppression method. The method comprises the steps of: providing at least one pre-driving current to a LED module, wherein the first pre-driving current provided is a first driving current, and the first driving current is less than a designed driving current of the LED module; and providing the designed driving current to the LED module.

By adopting the technical solution stated above, the LED driver circuit structure with over-current suppression of the present invention at least provides the following advantages and beneficial effects:

1. extending the lifespan of LEDs; and

2. increasing the PWM dimming frequency range for LED brightness control.

The above description is only a summary of the technical solution of the present invention. In order to shed more light on the technical means of the present invention, a detailed description of the preferred embodiments is provided below with reference to the accompanying drawings so that a person skilled in the art can easily understand the above and other objects, as well as the characteristics and advantages, of the present invention and implement the present invention according to the contents disclosed herein.

### BRIEF DESCRIPTION OF THE SEVERAL VIEWS OF THE DRAWINGS

FIG. 1 is a perspective view of a previously known LED driver circuit in the field of LED illumination applications;

FIG. 2 is a perspective view of a LED driver circuit structure with over-current suppression according to an embodiment of the present invention;

FIG. 3 is a perspective view of a voltage and current waveform diagram of a previously known LED driver circuit;

FIG. 4 is a perspective view of a voltage and current waveform diagram of another previously known LED driver circuit; and

FIG. 5 is a perspective view of a voltage and current waveform diagram according to an embodiment of the present invention.

FIG. 6 is an enlarged view in the current waveform of FIG. 5.

FIG. 7 is a perspective view of the procedure steps of a LED over-current suppression method according to an embodiment of the present invention.

### DETAILED DESCRIPTION OF THE EMBODIMENTS OF THE INVENTION

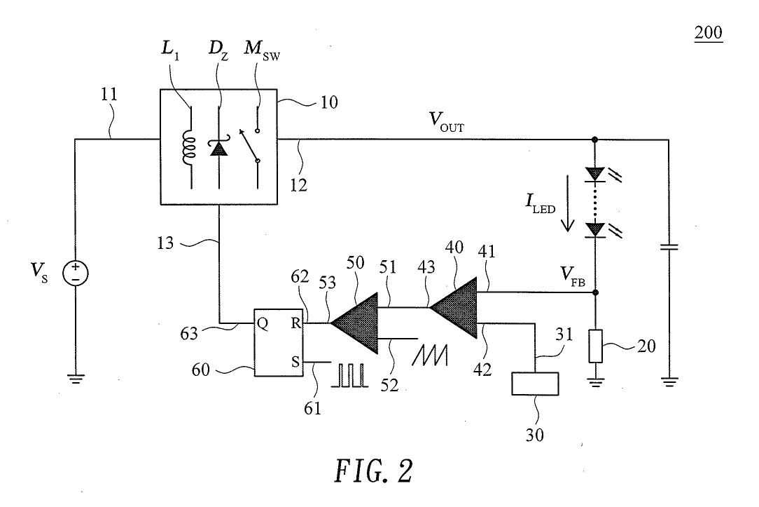

Referring to FIG. 2, it is a circuit diagram of an LED driver circuit structure 200 with over-current suppression according to the present invention. As shown in FIG. 2, the LED driver circuit structure 200 comprises a DC-DC converter 10, a voltage detector 20, a reference voltage supplier module 30, an error amplifier 40, a comparator 50, and an SR-latch 60.

The DC-DC converter 10 is a DC (direct current) to DC voltage converter. The DC-DC converter 10 receives an external DC voltage Vs via a voltage input node 11 of the DC-DC converter 10 and receives a control signal via a control signal input node 13 of the DC-DC converter 10, and output an output voltage V_{OUT} via a voltage output node 12 of the DC-DC converter 10 to supply an LED current I_{LED} to the LED module for lighting up the LEDs.

The DC-DC converter 10 further comprises an inductor L1, and an inductor current I_{L} passes through the inductor L1. The inductor current I_{L} has a designed maximum value I_{LMT}. The DC-DC converter 10 further comprises a MOSFET switch M_{SW} and a Zener diode D_{Z} for stabilizing the output voltage V_{OUT} of the DC-DC converter 10. The MOSFET switch M_{SW} and a PWM signal received at the control signal input node 13 together control the DC-DC converter 10 to obtain a switching voltage V_{SW}, which is feasible to observe a duty cycle of the PWM signal in the DC-DC converter 10.

The voltage detector 20 is connected in series with the LED module, such that the LED current I_{LED} also passes through the voltage detector 20. The voltage detector 20 obtains a detection voltage V_{FB} through the calculation of the LED current I_{LED} with the circuit of the voltage detector 20 and provides the detection voltage V_{FB} to the error amplifier 40.

The reference voltage supplier module 30 is to supply at least one pre-driving reference voltage and a designed reference voltage and has a reference voltage output node 31. The reference voltage supplier module 30 outputs the pre-driving reference voltage and the designed reference voltage via the reference voltage output node 31. The pre-driving reference voltage generated from the reference voltage supplier module 30 is set to be smaller than the designed reference voltage. And the designed reference voltage is defined as a voltage for controlling the output voltage V_{OUT} of the DC-DC converter 10 such that the LED current I_{LED} passing through the LED module is a designed driving current.

The error amplifier 40 has a first input node 41, a second input node 42, and a first output node 43. The first input node 41 is electrically connected to the output node of the voltage detector 20 so as to input the detection voltage V_{FB}. The second input node 42 is electrically connected to the reference voltage output node 31. The error amplifier 40 compares the voltage at the first input node 41 and the voltage at the second input node 42 and propagates a result of the comparison to the first output node 43.

The comparator 50 has a third input node 51, a fourth input node 52, and a second output node 53. The third input node 51 is electrically connected to the first output node 43. The fourth input node 52 is electrically connected to a saw-tooth voltage source. Under the control of the comparator 50, which is based on a comparison result received at the third input node 51 and the saw-tooth voltage input at the fourth input node 52, is sent from the second output node 53, thereby providing a controlled PWM signal.

The SR-latch 60 has a fifth input node 61, a sixth input node 62, and a third output node 63. A clock signal is connected to the fifth input node 61, and the sixth input node 62 is electrically connected to the second output node 53. The clock signal input to the fifth input node 61 determines whether the SR-latch 60 sends a signal received from the sixth input node 62 to the third output node 63, which is connected to the control signal input node 13 of the DC-DC converter 10. Hence, the control of the SR-latch 60 ensures that only one PWM signal is triggered in each clock cycle, and thereby no abnormal function of PWM occurs.

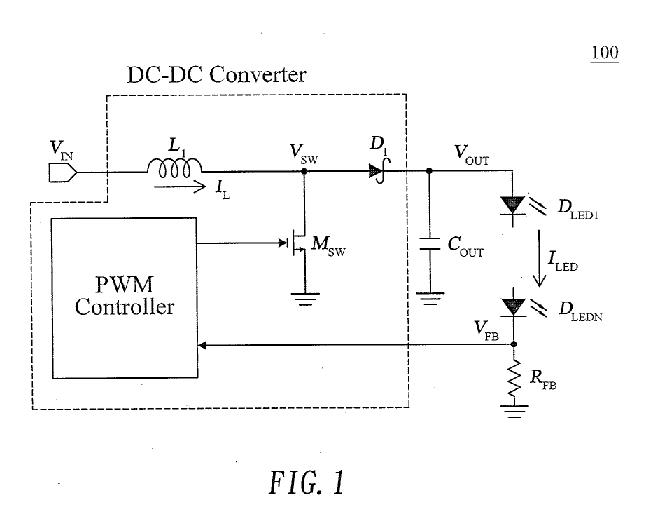

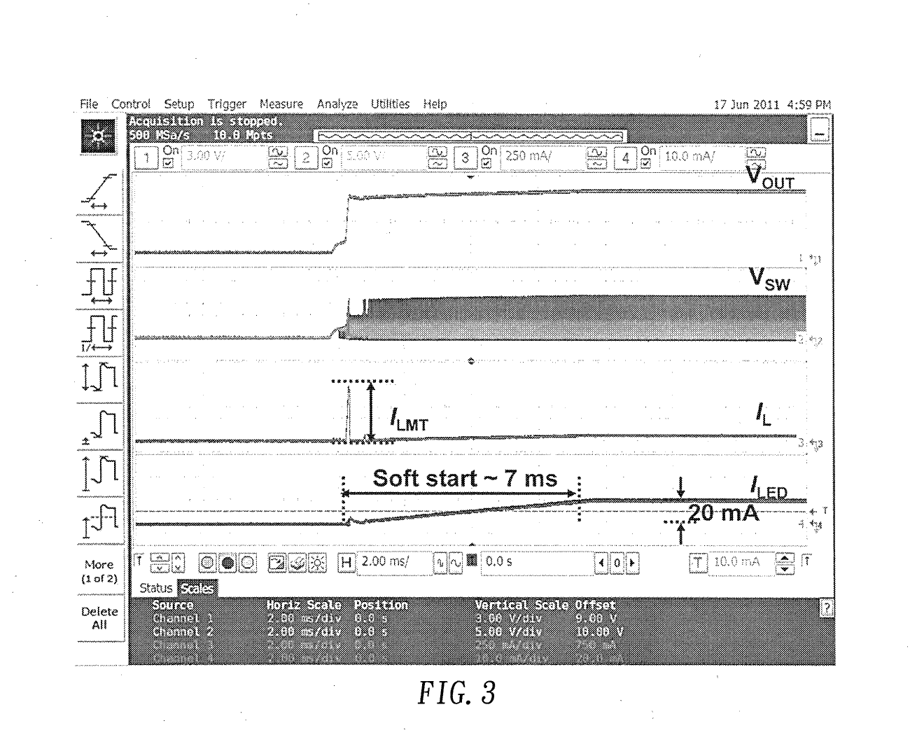

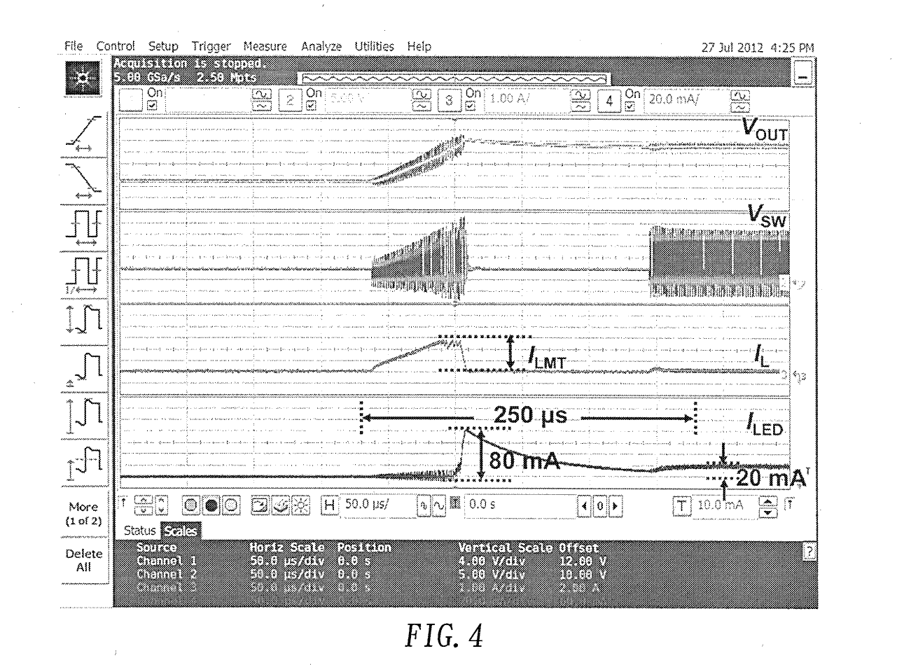

Referring to FIG. 3 and FIG. 4, there show the voltage and current waveform diagrams of a conventional LED driving circuit. V_{OUT}, I_{LED}, I_{L}, I_{LMT} and V_{SW} in the drawings are described as follows: Please also refer back to FIG. 1, the output voltage V_{OUT} of the DC-DC converter 10 supplies an LED current I_{LED} to an LED module in order to light up the LEDs. An inductor current I_{L} passes through the inductor L1 of the DC-DC converter 10, and the inductor current I_{L} has a designed maximum value I_{LMT}. The switching voltage V_{SW} is the voltage resulting from controlling the DC-DC converter 10 by means of the PWM signal and M_{SW}.

Referring to FIG. 3, a drawback of the conventional driving circuit is that, the LED current I_{LED}, which flows through the LED module to light up the LEDs, features an overly long time delay, 7 ms as shown in FIG. 3, in reaching the designed driving current from startup. The overly long time delay occupies an overly large portion of one cycle period (given a clock frequency of 120 Hz, the clock cycle period is approximately 8 ms). As a result, the PWM dimming frequency range is greatly reduced (1 ms left in this example of the clock frequency being 120 Hz), thereby reducing greatly the effective PWM dimming frequency range of LED brightness control.

Referring to FIG. 4, another drawback of the conventional driving circuit is that, at startup, the conventional driving circuit generates a current surge of 80 mA, which is four times as large as the designed driving current, and is called the over current (in this embodiment, the designed driving current is 20 mA), the over current shortens the lifespan of all the LEDs in the LED module greatly.

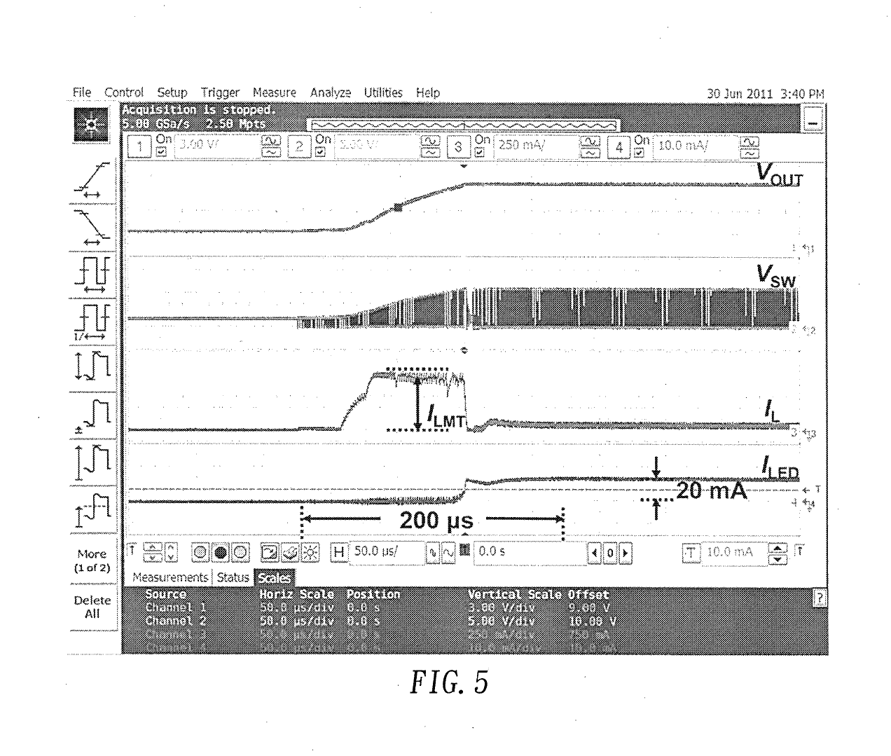

Referring to FIG. 5, there are shown voltage and current waveforms of a driver circuit for suppressing an LED over current according to an embodiment of the present invention. In this embodiment, the reference voltage supplier module 30 applies a pre-driving reference voltage and a designed reference voltage, wherein the pre-driving reference voltage is less than the designed reference voltage.

Referring to FIG. 5, an embodiment of the present invention, the pre-driving reference voltage controls the output voltage V_{OUT} of the DC-DC converter 10 so as to limit the LED current I_{LED} been smaller than designed driving current. In this regard, although a over current (current surge) is also generated at startup, the magnitude of the current surge is suppressed to such an extent that it becomes no greater than the designed driving current, so that the LEDs will not have their lifespan shortened as those suffer a large surge current. In just an instant after evading the surge, the reference voltage supplier module 30 switches its output to the designed reference voltage so as to raise and maintain the LED current I_{LED} at the stable designed driving current, thereby lighting up the LEDs steadily.

As also referring to FIG. 5, since the duration of suppressing current is greatly reduced to 200 μs which accounts for just a tiny portion of a clock period (given a frequency of 120 Hz, the clock period is 8 ms approximately), the PWM dimming frequency range is no longer greatly reduced (7.8 ms (8 ms-200 μs) left in this example where the clock frequency being 120 Hz), thereby the effective PWM dimming frequency range of LED brightness control is greatly improved to a value almost equal to the full cycle time (=7.8/8, which is 97.5% tuning range in one clock cycle).

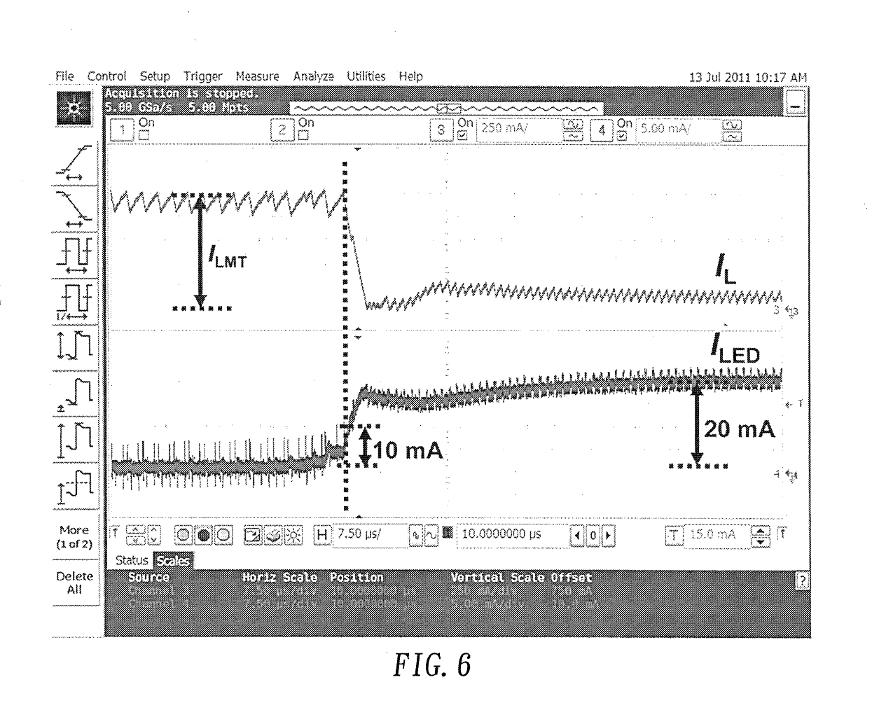

Referring to FIG. 6, there is shown a potion of a current waveform of the driver circuit 200 with LED over-current suppression according to an embodiment of the present invention. As indicated by the LED current I_{LED} waveform shown in FIG. 6, the driver circuit 200 with LED over-current suppression in an embodiment of the present invention generates a pre-driving reference voltage smaller than the designed reference voltage to limit the pre-driving current to 10 mA (less than 20 mA). The pre-driving current of 10 mA effectively suppresses a current surge which might otherwise be quite large and be generated instantaneously at startup of the circuit. By this way, the driver circuit 200 with LED over-current suppression according to an embodiment of the present invention protects the LEDs against an over-current and prevents the reduction in the lifespan of the LEDs.

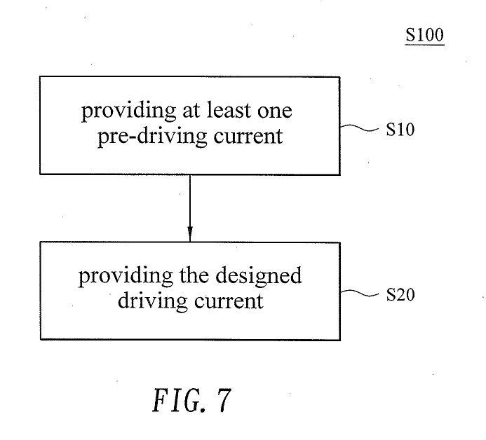

Please Refer to FIG. 7, there is shown a schematic view of a LED over-current suppression method (S100) according to the present invention. The LED over-current suppression method (S100) comprises the following steps: providing at least one pre-driving current (step S10) to a LED module, wherein the first pre-driving current of the at least one pre-driving current provided is a first driving current, and the first driving current is less than a designed driving current of the LED module; and providing the designed driving current (step S20) to the LED module, wherein the designed driving current of the LED module is set in the original design of the LED module.

Referring to FIG. 7, the LED over-current suppression method (S100) of the present invention provides an LED module with at least two driving currents to achieve the over-current suppression of the LED driving current, and the first driving current provided has to be smaller than the designed driving current. And the driving currents provided before the designed driving current is called the pre-driving currents. To emphasize again, regardless of the number of the driving currents, the first driving current provided is always set to a value smaller than the designed driving current of the LED module in order to reduce efficiently and greatly the current surge generated instantaneously at startup.

The embodiments described above are only the preferred embodiments of, but not limitations to, the present invention. While the present invention is disclosed herein with reference to the preferred embodiments, the embodiments are not intended to restrict the present invention. Based on the technical contents disclosed herein, a person skilled in the art may alter or modify the foregoing embodiments and thereby produce equivalent embodiments without departing from the scope of the present invention. Therefore, all minor alterations and equivalent changes which are based on the technical substance of the present invention and made to the foregoing embodiments should be considered as within the scope of the technical solution of the present invention.

What is claimed is:

1. An LED driver circuit structure with over-current suppression, comprising:
a DC-DC converter supplying a driving power to an LED module and having a voltage input node, a voltage output node, and a control signal input node;
a voltage detector connected in series with the LED module;
a reference voltage supplier module supplying at least a pre-driving reference voltage and a designed reference voltage and having a reference voltage output node;
an error amplifier having a first input node, a second input node, and a first output node, the first input node being electrically connected to an output node of the voltage detector, and the second input node being electrically connected to the reference voltage output node;
a comparator having a third input node, a fourth input node, and a second output node, the third input node being electrically connected to the first output node, and the fourth input node being electrically connected to a saw-tooth voltage source;
an SR-latch having a fifth input node, a sixth input node, and a third output node, the fifth input node receiving a clock signal, and the sixth input node being electrically connected to the second output node, and the clock signal determining whether to deliver the signal of the sixth input node to the control signal input node of the DC-DC converter.

2. The driver circuit structure of claim 1, wherein the reference voltage supplier module outputs the pre-driving reference voltage and the designed reference voltage via the reference voltage output node.

3. The driver circuit structure of claim 1, wherein the first pre-driving reference voltage generated from the reference voltage supplier module is smaller than the designed reference voltage.

4. The driver circuit structure of claim 1, wherein the comparator is a PWM controller.

5. A LED over-current suppression method, comprising the steps of:
providing at least one pre-driving current to a LED module, wherein the first pre-driving current provided is a first driving current, and the first driving current is less than a designed driving current of the LED module; and
providing the designed driving current to the LED module.
